(19) United States
(12) Patent Application Publication
(10) Pub. No.: US 2014/0367893 A1
(43) Pub. Date: Dec. 18, 2014

(54) METHOD AND APPARATUS FOR FORMING A POLYCARBONATE PANEL

(71) Applicants: Stephen J. Motosko, Sarasota, FL (US); Stephen J., Motosko, III, Sarasota, FL (US); Catherine Motosko, Sarasota, FL (US)

(72) Inventors: Stephen J. Motosko, Sarasota, FL (US); Stephen J., Motosko, III, Sarasota, FL (US); Catherine Motosko, Sarasota, FL (US)

(21) Appl. No.: 14/307,950

(22) Filed: Jun. 18, 2014

Related U.S. Application Data
(60) Provisional application No. 61/836,346, filed on Jun. 18, 2013.

(51) Int. Cl. B29C 51/08; B29C 51/42; B29C 53/24; B29C 51/26

(52) U.S. Cl. CPC B29C 51/08; B29C 51/264; B29C 51/421; B29C 51/428; B29C 51/261; B29C 53/24
USPC 264/446; 264/138; 425/174; 425/384; 425/396

(57) ABSTRACT

A method for forming a polycarbonate panel, the method comprising the steps of cutting a flat polycarbonate panel to the desired final dimensions, inserting the panel between the two portions of a die, forming the panel by means of compression between the two portions of the die, overbending the panel between 1-12 degrees to achieve a predetermined angle of bends in the panel and repeating these steps until the panel is fully corrugated. The method further includes the steps of heating the die and/or the panel by means of an electric strip temperature of between 100-110 degrees Fahrenheit. An apparatus is also provided for forming a polycarbonate panel. The apparatus includes a die where the die includes a first portion and a second portion. The die being automatically adjustable in height and width. The first portion and the second portion movable with respect to each other and the first portion and the second portion operable to compress and overbend a panel to form a bend in the panel.

### CROSS-REFERENCE TO RELATED APPLICATIONS

This application claims priority of U.S. Provisional Application 61/836,346 filed Jun. 18, 2013, the contents of which are incorporated herein by reference.

### FIELD OF THE INVENTION

The present invention relates generally to stamping methods for forming a part. More particularly, the present invention relates to a method and apparatus for forming via stamping a polycarbonate panel for use with a storm protection system.

### BACKGROUND OF THE INVENTION

Polycarbonate panels for covering a window or other opening to a window to prevent storm damage are known. These panels are created by extruding a plastic or similar material to form a corrugated panel. The extrusion method and apparatus requires expensive dies and extrusion systems to create a panel. Furthermore, the extrusion method does not allow the user to preselect the size of the finished panel.

Corrugated panels, versus flat panels, add strength and resiliency to the panels in the event of high winds, rain, sleet, and debris during a storm. These panels are typically affixed over a window or other building opening to resist the wind, rain, sleet, and debris during a storm. The corrugated panels may be fixed or removable over the building openings.

Thermoforming is also a known method of forming a corrugated panel for a hurricane protection system. However, Thermoforming required high temperatures (250 degrees or more) and does not provide for allowing application or installation of any protection layer.

Accordingly, there exists a need in the art to provide a method and apparatus for creating a corrugated panel having sufficient resiliency and strength to withstand a storm while simultaneously minimizing waste during the manufacturing process.

### SUMMARY OF THE INVENTION

A method for forming a polycarbonate panel is provided. The method comprising the steps of cutting a flat polycarbonate panel to the desired final dimensions, inserting the panel between the two portions of a die, forming the panel by means of compression between the two portions of the die, overbending the panel between 1-12 degrees to achieve a predetermined angle of bends in the panel and repeating these steps until the panel is fully corrugated. The method further includes the steps of heating the die and/or the panel by means of an electric strip temperature of between 100-110 degrees Fahrenheit.

The die assembly is automatically adjustable and connected to a controller for adjustment. The controller is in communication with the die and an actuator to move and adjust the plate and portions of the die assembly to achieve the desired finished product. The method further includes the step of stretching the polycarbonate within the die to improve strength and resiliency and adding corner pockets and sub-molds in the die. The method further comprising the step of applying polyethylene film to the panel before forming the panel, forming the panel with the polyethylene film positioned thereon. A spring plate may be provided to align the panel and to prevent slipping of the panel during forming. The method may further comprise the step of gas plasma treating the surface of the polycarbonate panel before forming. The lower required temperature for forming (100-110 degrees Fahrenheit) does not (or at least minimally) alter the properties of the polycarbonate thus improving strength and resiliency.

An apparatus is also provided for forming a polycarbonate panel. The panel is adapted for mounting over an opening to a building for protection during inclement weather. The apparatus includes a die where the die includes a first portion and a second portion. The die being automatically adjustable in height and width. The first portion and the second portion movable with respect to each other and the first portion and the second portion operable to compress a panel to form a bend in the panel. A heater is connected to the apparatus operable to slightly raise the temperature of the panel and/or the die to a predetermined temperature slightly above ambient temperature, the heater operable to raise the temperature of the panel and/or the die to between 100-110 degrees Fahrenheit. The first portion and the second portion of the die are both dimensioned 1-12 degrees over than the desired final bend angle of the finished bend in the panel to accommodate for the polycarbonate relaxing when at room temperature. A cooler may also be provided to cool either the die and/or the panel to a predetermined temperature of between 100-110 degrees Fahrenheit. The die may include at least one sub-mold, corner pocket and corresponding protrusion to facilitate stretching of the polycarbonate panel during forming. A spring plate is provided to facilitate alignment of the panel during forming and to prevent slippage of the panel during forming. A plasma treating apparatus may also be provided to apply gas plasma to the die before forming.

The described method and apparatus is unique when used with polycarbonate and polyethylene film. Polycarbonate normally requires a temperature of over 250 degrees Fahrenheit to properly bend. The above mentioned method and apparatus do not require such a high temperature. This high temperature require expending extra energy and time for the panel and/or dies to reach such a high temperature. Overbending of the present invention does not require such a high temperature (the current method only requires a temperature of 100-110 degrees Fahrenheit). The lower temperature requirement, because of the overbending unique to polycarbonate, is less costly and time consuming to the user. Accordingly, this method and apparatus provided for unexpected results when used specifically with polycarbonate (and a polyethylene film).

### BRIEF DESCRIPTION OF THE DRAWINGS

FIG. 1 illustrates a cross-sectional view of a first embodiment of the present invention;

FIG. 2 illustrates a cross-sectional view of the press of an alternative embodiment of the present invention;

FIG. 3 illustrates a cross-sectional view of yet another alternative embodiment of the present invention;

FIG. 4 illustrates yet another alternative embodiment of the press of the present invention;

FIG. 5 illustrates a cross-sectional view with force arrows illustrating the pressing during the forming process of the corrugated panel;

FIG. 6 illustrates a cross-section view of one embodiments of the corrugated panel;

FIG. 7 illustrates an alternative embodiment cross-sectional view of the finished panel of the present invention;

FIG. 8 illustrates the method of forming the corrugated panel;

FIG. 9 illustrates the finished product of the corrugated panel, this panel may also contain apertures or grommets for mounting; and

FIG. 10 illustrates the panel being inserted between the die portions before forming.

### DETAILED DESCRIPTION OF THE INVENTION

The present invention provides for a method and apparatus for forming a corrugated panel by using over bending to achieve the desired angle. The method achieves the finished desired angle by over bending the polycarbonate panel by 1 to 12 degrees over the finished desired angle. Heating and/or cooling may be used to adjust the temperature to a temperature of approximately 100 to 110 degrees. Stretching occurs between the press which increases the strength of the polycarbonate panel thus improving performance. Stretching may also occur at the sub-molds or at the corner pockets and corresponding protrusions. A flat piece of polycarbonate material is first cut to the desired finished size and the pressing occurs after the cutting to reduce waste. This allows for customization of the panel size to the user. Rolls of polycarbonate material are obtained in 450 to 650 feet lengths. These rolls are obtained when the polycarbonate is in a flat configuration. The polycarbonate material is then cut to the desired finished size to accommodate the window or other opening within a building and customized to the specific size. Cutting before forming provides for dramatically reduced waste as compared to cutting the panel after the corrugation forming process. Waste on shorter length materials is reduced in the 8 to 10% range, while waste of the 400 to 650 foot rolls is reduced to nearly zero.

As shown by FIG. 10, the apparatus of the present invention is generally comprised of a first part 1102 and a second part 1104 operable to be pressed together to form the corrugated panel. The flat panel 1100 is inserted manually or otherwise into the press and an actuator presses the first portion and the second portion together to form the corrugated panel. The press or die is installed into a machine, such as shown in FIG. 10, and is formed with the help of a user.

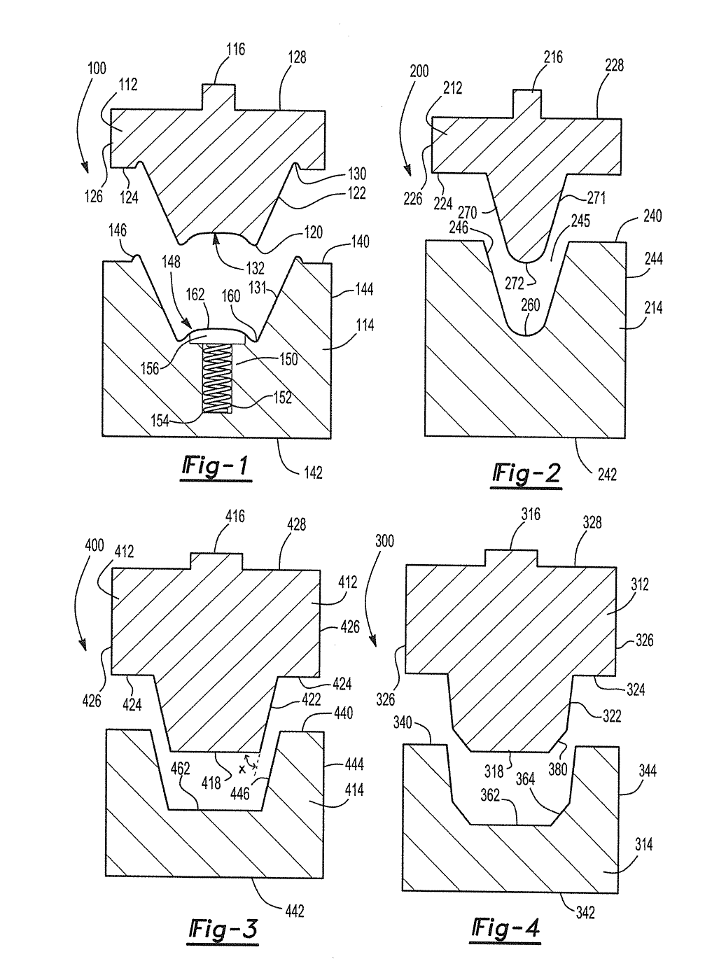

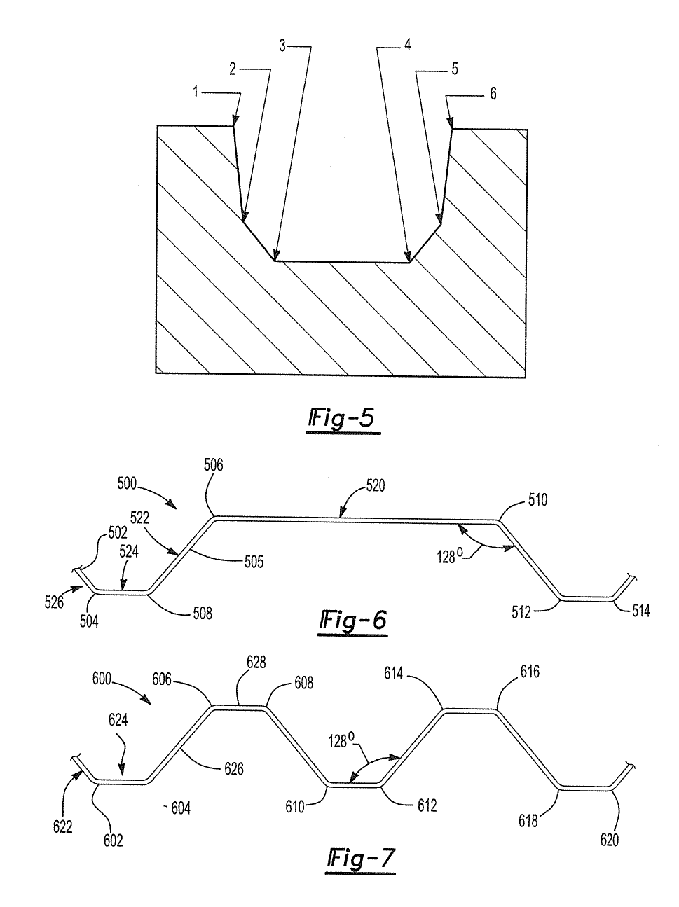

FIGS. 1, 2, 3, and 5 illustrate various embodiments of the press having different angles. Now in reference to FIG. 1. The die 100 includes a first portion 112 and a second portion 114. The first portion, or upper portion, includes an upper end 116 and a lower end 118. The upper end 116 is configured to connect to a machine or apparatus to hold the first portion 112. The upper portion 116 of the first portion 112 of the die 100 includes an upper generally planar portion 128 and a side portion 126. These portions are also configured to connect to a machine for pressing. A lower middle portion 124 is also configured to connect to the apparatus. Surfaces 122, 132 are adapted to form the angled surfaces of the panel. These angles of the die 100 are configured to over bend the panel by 1 to 12 degrees (typically 1 to 3 degrees) to achieve the exact desired finish angle of the corrugated panel. The over bending of 1 to 12 degrees compensates for the polycarbonate cooling and resting thus resulting in a more accurate finished panel. The panel must be let to cool (for up to 24 hours) for the panel to achieve the desired final angle. The panel should be cooled to ambient or room temperature before shipping or use.

The second portion 114 includes an upper portion 140 and a lower portion 142. A side portion 144 is also provided configured allowing the pressing apparatus to hold the second portion 114. An interior portion 162 is provided having a surface 148 configured to connect with the surface 132 of the first portion 112. Again, over bending of 1 to 12 degrees is provided in the die to facilitate a correct finished angle of the panel.

A spring plate 150 is provided having an interior cavity 152 and a spring 154. The spring plate 150 is provided having a pressing member 156 in connection with the surface 148 of the second portion 114. The spring plate and spring apparatus is adapted to facilitate removal of the panel from the die 100 after the pressing is complete. In alternative embodiments, the spring 154 may be a hydraulic actuator or other form of spring. The second portion 114 of the die 100 further includes interior surfaces 146 operable to connect with the outer angled surface 122 of the first portion 112 of the die 100. The die 100 also includes submolds or corner pockets 130. The corner pockets 130 are provided at a middle lower portion of the first portion 112 of the die 100 which corresponds to a protrusion 131 of the second portion 114 of the die 100. These corner pockets facilitate stretching of the polycarbonate within the die 100 during pressing. It should be noted that the die may have a plurality of protrusions and depressions such as shown at 130, 131 (submolds) to achieve a corrugated polycarbonate panel in less time. A die having a plurality of submolds will have the same arches, geometry, corner pockets, etc. as adjacent submolds.

The spring plate 150 is operable to create an opposite force of the mold against the polycarbonate panel during the forming process to align the panel and keep the panel from slipping. The protrusions or submolds 130, 131 also facilitate in aligning the panel and keeping the panel from slipping. The spring plate 150 is used in connection with the arch as illustrated at surface 148 to create a planar/flat portion of the finished corrugated polycarbonate panel. As shown in FIG. 1, the at least two corner pockets and corresponding protrusions 130, 131 help maintain a consistent angle on the corrugated polycarbonate finished panel. Typically, different length panels require different tonnage to achieve the same angle. The submolds 130, 131 of FIG. 1 work like an air bending acute die to achieve consistent bends over the varying length panels at the same tonnage. The submolds 130, 131 achieve a smooth bend and curve around the bend by over bending at the corners. The submolds 130, 131 also facilitate stretching to improve resiliency and strength of the finished panel.

The apparatus and method includes inserting the panel into the assembly one or more times to achieve the desired radius and profile. Over bending of the polycarbonate is required to achieve the desired final angle. By way of example, a bend in the die 100, or any of the other dies mentioned below, of 85 degrees is necessary to achieve a final radius of 60 degrees in the panel. Greater bending angles can be achieved by pre-arching the polycarbonate in the opposite direction but not to the point that it will permanently set. The pre-arch, as illustrated by surface 148 of FIG. 1, section will snap and return the flat, planar portion due to over bending in the polycarbonate. Alternatively, to get to 90 degrees, two 45 degree bends may be performed to achieve the final 90 degree bend.

FIG. 2 illustrates an alternative embodiment to the die 100 of FIG. 1. The die 200 includes a first portion 212 and a second portion 214. The first portion 212 includes an upper first end 216 having a configuration adapted to connect to the pressing apparatus 228. Side portions and middle lower portions 224, 226 are also provided to assist in the forming of the polycarbonate panel. The first portion 212 includes an angled side wall 270 and a rounded tip 272 adapted to form a one bend portion of a polycarbonate panel. A second portion 214 is provided having upper portions 240 adapted to connect to the portion 224 to form generally planar portions of the polycarbonate panel. The second portion 214 includes side and lower portions 244, 242 adapted to connect to the forming apparatus. The indentation 245 is adapted having an angled side wall 246 and a radiused portion 260 adapted to connect to the protrusion 271 of the first portion 212.

FIG. 4 illustrates yet another alternative embodiment of the die 100. A die 300 is provided having a first portion 312 and a second portion 314. The first portion 312 includes an upper portion 316 having a generally planar upper surface 328. A side wall 326 is provided. A middle lower generally planar surface 324 is adapted to produce the generally planar portions of the finished panel. Angled side walls 322, 380 are provided to form the generally radiused portion of the finished panel. A lower surface 318 is adapted to provide a lower generally planar portion of the finished panel. The second portion 314 includes an upper surface 340 adapted to work in connection with the surface 324 of the first portion 312 to create a generally planar surface of the finished panel. Lower and side portions 342 and 344 are adapted to connect to the forming apparatus. The second portion 314 includes interior angled surfaces 364, 368 to provide the angled surfaces and radiused surfaces of the finished panel. The lower surface 362 is adapted to connect to the planar portion 318 of the first portion of the die 300.

FIG. 3 illustrates yet another alternative embodiment of the die 100. A die 400 is provided having a first portion 412 and a second portion 414. The first portion 412 includes an upper portion 416 having a generally planar upper surface 428 both adapted to connect to the apparatus for forming. A side wall 426 is also provided. A middle lower wall 424 and a lower wall 418 are adapted to rest adjacent to/connect to the upper surface 462 and 440 of the second portion 414. The lower portion 414 includes a side wall 444 and a lower wall 442 adapted to connect to the apparatus for forming.

The method includes the steps of cutting a roll of polycarbonate material to the finished size of the shutter to cover a window or other opening of a building. The method then includes the step of heating or cooling the panel and bending the die to the desired stable temperature. The temperature increase/decrease will not drastically but rather only vary within 5 to 30 degrees of the ambient temperature in an effort to keep the system stable. Other methods require increasing the polycarbonate temperature up to 250 degrees and dried of all moisture before forming. The present invention only requires the temperature to be just above ambient at 100 to 110 degrees Fahrenheit. Slightly warming ensures consistent bending. Cold bending of the polycarbonate can cause fractures in the bent area. Furthermore, it is recommended that the material only be radiused to 100 times its thickness.

The present invention only requires a stable temperature of 100 to 110 degrees Fahrenheit. Since the angle of the bend only partially depends on the plastic temperature, the present invention only requires a minimal temperature increase.

The dies as illustrated in FIGS. 1, 2, 3, and 5 may also be heated or cooled. The method of the present invention does not require drying to remove moisture before forming since the temperature increase is minimal. The method may further include the steps of incorporating a protective polyethylene layer on both sides of the finished panel. The polyethylene layer is provided on the polycarbonate material before forming. Since the temperature increase is so minimal, the forming process between the dies does not damage the polyethylene layer. The polyethylene layer not only protects the polycarbonate during processing, it also protects the polycarbonate during shipping and installation. Without the polyethylene layer, the polycarbonate may become scratched and create an unappealing look to the user. The polyethylene layer may be left on during installation and use or may also be removed before installation and use.

The method may then include the step of plasma treating the surface of the area to be bent before the forming. The plasma surface treating takes place before the bending and before forming changes the surface tension as well as super cleaning the area allowing the empty peaks and valleys to fold within each other and create a fracture free reinforced corner.

The inclusion of a plasma process before, during, or after the die molding process is advantageous. Gas plasma allows for molecular engineering of materials to impart unique characteristics and surface properties without affecting the bulk properties of the whole material. The use of plasma in the forming of polycarbonate panels changes the surface characteristic such as changing in biocompatibility, surface energy, morphology, texture, and absorption.

The next step of the method includes compressing to form ribs or corrugation of the surface of the polycarbonate. The step includes compression of the bent area completely around the radius and/or in specific areas to create one or more compressed ribs thus creating the corrugated look. The compressing/bending requires 50 to 100 tons of pressure. The pressure will add additional heat to the bent/stretched area. This process and method creates a fracture free reinforced bent area. The maximum angle before fractioning and weakening is dependent on the material temperature, die temperature, compressing temperature, thickness of the material, and final desired angle.

The method of the present invention allows a user to make panels with any width panel, height of wave, width of wave, and frequency of the wave. Each of the dies as illustrated in FIGS. 1, 2, 3, and 5 may be adjusted by moving the various side panels and components of the die. Automatic adjustment is available for height of the wave (or corrugation) by the user inputting information into a computer connected to a controller. The controller then sends a signal to an actuator which adjusts the height of the bending portion (portion of a die). This automatic adjustment is available for the single punch formation of the panel (i.e. forming one bend at a time). The angles of the bend are controlled by the depth of the die or portion of the die. The user repeats the single punch (or bend) process until the entire panel is fully corrugated. The user can control the depth by means of a CNC controller (connected to a computer and a display screen).

FIG. 6 illustrates a cross-sectional view of two panels having different wavelengths. The panel 500 includes a plurality of radiused bends 504, 508, 506, 510, 512, 514. Each of these bends 128 is provided at a 128 degree angle. To achieve this 128 degree angle, the die must have an angle of 138 degrees plus. The panel 500 further includes a plurality of generally planar portions 502, 505 having generally planar surfaces 526, 522, 520. To achieve these planar portions and planar surfaces, the surfaces of the die may be slightly angled, such as illustrated in FIG. 1, to achieve the planar surface.

FIG. 7 illustrates the panel 600 which includes a plurality of radiused portions 602, 604, 606, 608, 610, 612, 614, 616, 618. A plurality of generally planar surfaces 622, 624, 628 are also provided between the radiused portions. Again, an angle of 128 degrees is provided between each of these portions. Over bending, such as described above, is also required to achieve these final angles of the polycarbonate panel.

The amount of deflection that a hurricane panel, such as those illustrated in FIGS. 6, 7 and 9, has on impact or design pressures is crucial. Polycarbonate panels react differently from steel or aluminum. Polycarbonate will deflect and return back to the original shape. Since there is less material to stretch out under pressure, a lower wave height may reduce deflection at the same impact or design pressure.

The final panel may also include aperture and/or apertures with grommets to reinforce the apertures.

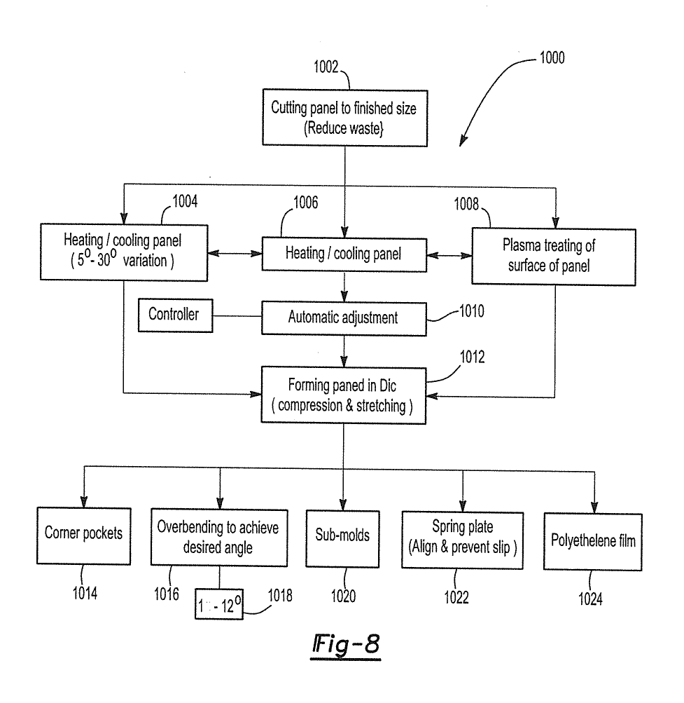

FIG. 8 illustrates the method 100 of the present invention. The method includes the steps of cutting the panel 1002 to a finished size to reduce waste. The panel is cut from a roll of polycarbonate material ranging from 450 to 650 feet in length. The panel may also be cut from a 20 foot sheet. Waste may be reduced to essentially zero when cut from the 450 to 650 foot sheets. The method then includes the steps of heating or cooling the panel to 100 to 110 degrees (a 5 degree to 30 degree variation from ambient temperature which is illustrated at reference numeral 1004). Before or after that step at 1004 the die may be heated or cooled as illustrated at reference numeral 1006. The panel or die may be heated or cooled by electric strip heaters placed on or adjacent the panel or the die. Before or after steps 1004 or 1006, plasma treating 1008 of the surface of the panel may be performed. Before forming the die, automatic adjustment of the dies as illustrated in FIGS. 1, 2, 3, and 5 may be performed as illustrated at reference numeral 1010. The die is then formed at reference numeral 1012 which includes compression and stretching of the polycarbonate material. The die may be manually inserted into the apparatus by using a stop or guide to direct the user how far to insert the panel into the forming machine. The panel may be inserted into the machine a plurality of times to achieve the desired corrugated final product. The following steps may also be performed before or after one another. Forming corner pockets 1014, over bending 1016 to achieve a desired angle (where the over bending is between 1 and 12 degrees as illustrated at reference numeral 1018), creating submolds 1020, providing a spring plate to prevent slippage and to align as illustrated at reference numeral 1022, and also providing a polyethylene film or layer to provide protection to the polycarbonate material.

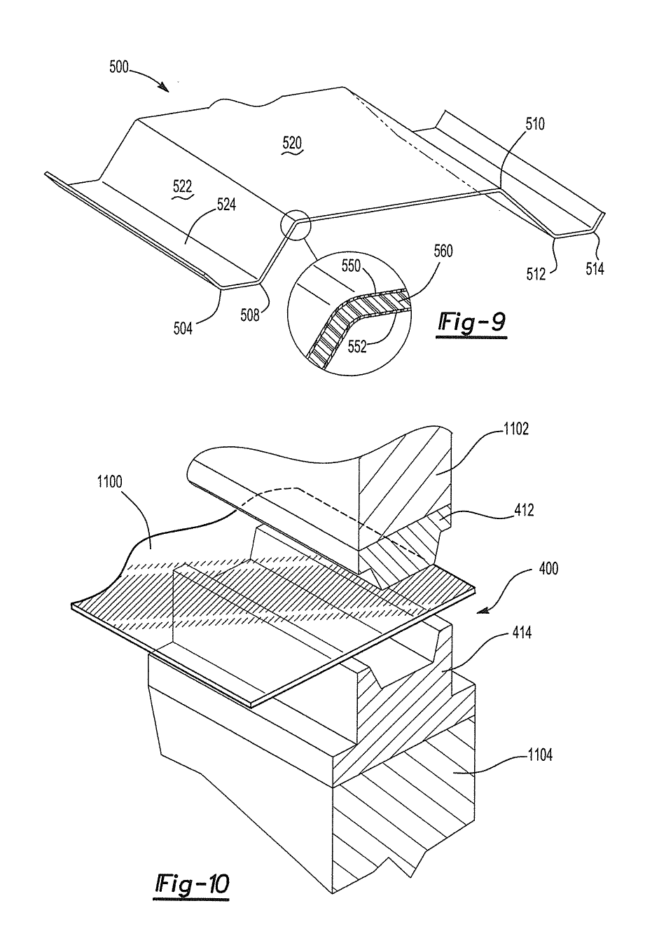

FIG. 9 illustrates a perspective view of the finished panel after the panel has been cooled. The panel includes the polyethylene film 550, 552 formed on the polycarbonate 560.

The above described method and apparatus is unique when used with polycarbonate and polyethylene film. Polycarbonate normally requires a temperature of over 250 degrees Fahrenheit to properly bend. The above mentioned method and apparatus do not require such a high temperature. This high temperature require expending extra energy and time for the panel and/or dies to reach such a high temperature. Overbending of the present invention does not require such a high temperature (the current method only requires a temperature of 100-110 degrees Fahrenheit). The lower temperature requirement, because of the overbending unique to polycarbonate, is less costly and time consuming to the user. Accordingly, this method and apparatus provided for unexpected results when used specifically with polycarbonate (and a polyethylene film).

The present apparatus and method allow the user to apply the film to the polycarbonate panel. Traditional stamping methods requires significantly higher temperatures (250 degrees or more). These traditional methods will melt the polyethylene film used for protection on the polycarbonate panel. Since the present invention utilizes overbending and only raising the temperature slightly (100-110 degrees Fahrenheit), the polyethylene film can be applied before forming. Accordingly, the present invention offers significant improvements over the prior art.

The overbending of the panel allows the user to use a lower temperature during forming. The overbending requires the die to be 1-12 degrees over the desired finished angle of the panel. After the panel is allowed to sit for 24 hours, the panel will reach it's final predetermined dimension. By way of example, FIG. 3 illustrates a cross-sectional view of a die used in the present invention. The die 400 is has angles 1-12 degrees over the desired finished angle of the product panel. As shown by X, this angle is 1-12 degrees smaller than the finished product. X in FIG. 3 is 1-12 degrees smaller than the desired predetermined angle of the finished panel. Right after the panel comes out of the mold, the angles will be 1-12 degrees smaller than the ultimate finished product. After 24 hours allowing the panel to cool, the panel will have angles measuring to the predetermined angles (1-12 degrees greater than the angles of the die). Furthermore, the time delay (1 to 30 seconds) at the bottom of the stroke also allows for the polycarbonate panel to set. The finished predetermined angle being 1-12 degrees greater than the angle of the bend in the die.

The invention is not restricted to the illustrative examples and embodiments described above. The embodiments are not intended as limitations on the scope of the invention. Methods, apparatus, compositions, and the like described herein are exemplary and not intended as limitations on the scope of the invention. Changes therein and other uses will occur to those skilled in the art. The scope of the invention is defined by the scope of the appended claims.

1. A method for forming a polycarbonate panel for use with a storm protection system, the method comprising the steps of:
cutting a flat polycarbonate panel to a predetermined final dimension;
inserting at least a portion of the panel between the two portions of a die;
compressing the panel between two portion of the die to form a bend in the die;
overbending the panel between to achieve a finished predetermined angle of a bend in the panel, the first portion and the second portion of the die both dimensioned 1-12 degrees over than the desired final bend angle of the finished bend in the panel to accommodate for the polycarbonate relaxing when at room temperature, the finished predetermined angle being 1-12 degrees greater than the angle of the bend in the die;
repeating the above steps until the panel is fully corrugated; and
allowing the panel to cool to room temperature before use.

2. The method of claim 1 further comprising the steps of heating the panel by means of an electric strip heater.

3. The method of claim 2 further comprising the steps of heating the panel to a temperature of between 100-110 degrees Fahrenheit.

4. The method of claim 1 further comprising the step of heating the die by means of an electric strip heater.

5. The method of claim 3 further comprising the step of heating the die to a temperature of between 100-110 degrees Fahrenheit.

6. The method of claim 1 further comprising the step of automatically adjusting the die assembly.

7. The method of claim 1 further comprising the step of stretching the polycarbonate within the die to improve strength and resiliency.

8. The method of claim 1 further comprising the step of forming corner pockets in the panel.

9. The method of claim 1 further comprising the step of forming sub-molds in the die.

10. The method of claim 1 further comprising the step of applying polyethylene film to the panel before forming the panel, forming the panel with the polyethylene film positioned thereon.

11. The method of claim 1 further comprising the step of providing for a spring plate in the die to align the panel and to prevent slipping of the panel during forming.

12. The method of claim 1 further comprising the step of gas plasma treating the surface of the polycarbonate panel before forming.

13. An apparatus for forming a polycarbonate panel, the panel for mounting over an opening to a building for protection during inclement weather, the apparatus comprising:
a die, the die having a first portion and a second portion, the die being automatically adjustable in height and width, the first portion and the second portion movable with respect to each other, the first portion and the second portion operable to compress a panel to form a bend in the panel; and
a heater, the heater operable to slightly raise the temperature of the panel and/or the die to a predetermined temperature slightly above ambient temperature, the heater operable to raise the temperature of the panel and/or the die to between 100-110 degrees Fahrenheit.
the first portion and the second portion of the die both dimensioned 1-12 degrees over than the desired final bend angle of the finished bend in the panel to accommodate for the polycarbonate relaxing when at room temperature.

14. The apparatus of claim 13 wherein cooling apparatus is provided to cool either the die and/or the panel to a predetermined temperature of between 100-110 degrees Fahrenheit.

15. The apparatus of claim 13 wherein the die includes at least one sub-mold.

16. The apparatus of claim 13 wherein the die includes at least one corner pocket and corresponding protrusion to facilitate stretching of the polycarbonate panel during forming.

17. The apparatus of claim 13 wherein a spring plate is provided to facilitate alignment of the panel during forming and to prevent slippage of the panel during forming.

18. The apparatus of claim 17 wherein the spring plate is positioned connected to a second portion of the die.

19. The apparatus of claim 13 wherein a plasma treating apparatus is provided to apply gas plasma to the die before forming.
